(19) United States
(12) Patent Application Publication
(10) Pub. No.: US 2014/0336928 A1
(43) Pub. Date: Nov. 13, 2014

(54) System and Method of Automated Civil Infrastructure Metrology for Inspection, Analysis, and Information Modeling

(71) Applicant: Michael L. Scott, Kensington, MD (US)

(72) Inventor: Michael L. Scott, Kensington, MD (US)

(21) Appl. No.: 14/275,735

(22) Filed: May 12, 2014

Related U.S. Application Data
(60) Provisional application No. 61/821,755, filed on May 10, 2013.

(51) Int. Cl. G01N 21/88; B64C 13/00

(52) U.S. Cl. CPC G01N 21/88; B64C 13/00; B64C 2201/145
USPC 701/468

(57) ABSTRACT

A system and method of automated civil infrastructure metrology for inspection, analysis, and information modeling utilizes an unmanned aerial vehicle (UAV) equipped with a position tracking system and digital cameras to capture a plurality of images of a structure to be inspected. The UAV is flown in a scan pattern around the structure while continually capturing images of the structure while position and orientation data is also recorded and linked for each of the images. Image processing and pattern recognition software algorithms are used to analyze the images and create an information model of the structure which is then used to carry out a virtual inspection of the structure in a three dimensional software environment.

The current application claims a priority to the U.S. Provisional Patent application Ser. No. 61/821,755 filed on May 10, 2013. The current application is filed in the U.S. on May 12, 2014 while May 10, 2014 was on a weekend.

### FIELD OF THE INVENTION

The present invention relates generally to inspection of civil infrastructure. More particularly, the present invention relates to an automated civil infrastructure metrology system for inspection and evaluation of bridges, dams, buildings and other structures.

### BACKGROUND OF THE INVENTION

Inspection, measurement, evaluation, and documentation of civil infrastructure such as U.S. bridge structures are currently labor intensive tasks. These tasks are increasingly demanding due to U.S. Federal Government requirements for frequent bridge inspections (at least biannual, [AASHTO, 2011; U.S. Fed. Reg., 2004]) combined with the increasing age and scope of the U.S. infrastructure [Chase, 2003].

A need exists for an automated technique to acquire measurement and visual inspection data with corresponding survey accurate position information for IM, analysis, database population, engineering evaluation, and decision making. Meeting this need can reduce labor costs and provide information directly to engineers and decision makers (who ultimately use the inspection information and measurement results to allocate resources).

Existing techniques do not automate repetitious tasks and the information they provide is often qualitative (based on inspector judgment which varies significantly [Moore, 2001]). These existing techniques include visual inspection and more recently developed photogrammetry techniques, which both require substantial field labor and still provide inconsistent, qualitative data [Moore, 2001; Jauregui, 2005]. Laser Imaging Detection and Ranging (LIDAR) also requires substantial field labor yet provides only geometric images of local features, (lacking texture, detail, and realistic means to capture features occluded from view or difficult to access views of).

The present invention uses a new metrology technique, including an automated Unmanned Aerial Vehicle (UAV) sensor platform to collect position referenced images and complementary sensor data with improved accuracy versus conventional surveys. Efficient, repeatable results can be obtained for many applications including periodic inspections and Information Modeling (IM). Automated UAV navigation within the metrology enabled space (around and within target structures) can provide full coverage of features for complete visual inspection and IM. United States (U.S.) Federal Government requirements to inspect more than 500,000 bridge structures biannually are an important motivation for data collection, inspection, and IM using the low cost, thorough, and accurate ACMS approach. Further, ACMS outputs provide a position referenced framework compatible with many types of complementary data and analysis.

The unique, novel ACMS approach provides consistent, quantitative engineering information using systematic, user friendly protocols. ACMS offers a new, efficient, and repeatable technique to acquire quantitative inspection and as-built civil infrastructure measurements including metrology images. ACMS is nonintrusive and can be performed on almost any civil infrastructure type or geometry including bridges, buildings, dams, and many others.

### BRIEF DESCRIPTION OF THE DRAWINGS

FIG. 1 is a description of ACMS sensors, system hardware, sensor data inputs and outputs.

FIG. 2 is a diagram showing the ACMS system with iGPS and/or VIO for the position tracking system.

FIG. 3 is a diagram showing an example scan pattern around a structure.

FIG. 4 is a pair of diagrams showing the electronic connections for the UAV.

FIG. 5 is a stepwise flow diagram describing the method of the present invention.

FIG. 6 is a stepwise flow diagram describing the method of the present invention.

FIG. 7 is a stepwise flow diagram describing the method of the present invention.

FIG. 8 is a stepwise flow diagram describing the method of the present invention.

FIG. 9 is a stepwise flow diagram describing the method of the present invention.

FIG. 10 is a stepwise flow diagram describing the method of the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a system and method for carrying out automated civil infrastructure metrology for inspection and evaluation of bridges, dams, buildings and other large structures. The present invention primarily relates to inspection of bridges, but may also be used to inspect and evaluate other structures. The present invention is preferably referred to as an Automated Civil Infrastructure Metrology System, or ACMS. The ACMS embodies a new metrology and inspection technique, offering quantitative measurement and evaluation capabilities that are repeatable and suitable for IM, visual inspection data collection and database population. ACMS data analysis can be automated using straightforward algorithms that do not require expert intervention. A critical aspect of ACMS is automated navigation of an unmanned aerial vehicle (UAV) platform over, around, and in special cases within a bridge. Bridge plans can be used to manually specify an ACMS scan pattern that covers a bridge or a fully automated scan pattern derived using bridge plan input information. ACMS results provide efficient, repeatable results for IM, database population such as, but not limited to, PONTIS or Bridge Management (BrM) software corresponding to an American Association of State Highway and Transportation Officials (AASHTO) BrM software package, and IM, and many other applications. The BrM software is utilized in the preferred embodiment of the present invention.

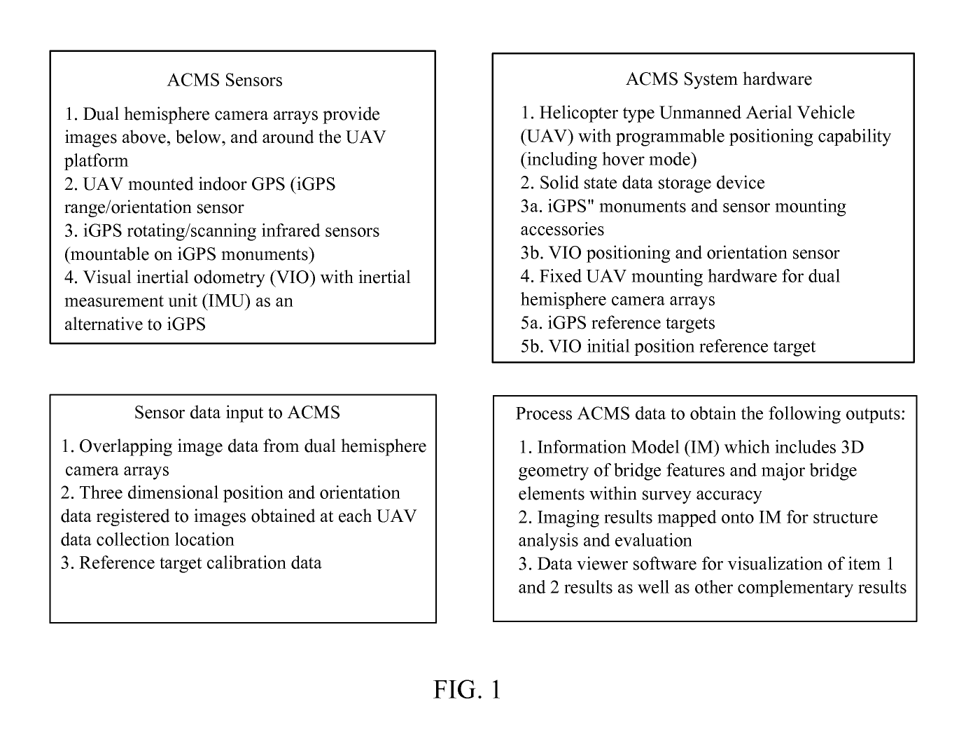

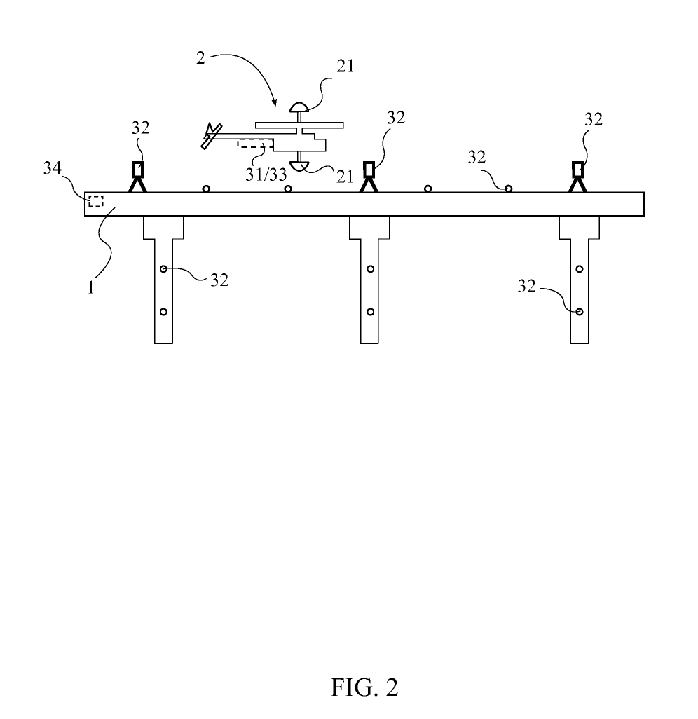

Referring to FIGS. 1-2, the system of the present invention generally comprises a UAV 2, a position tracking system 3 for the UAV 2, and pattern recognition and image analysis software. The present invention also comprises a computing system and database, wherein the computing system should be understood to receive, store and send any relevant data and perform any relevant calculations or other operations. The computing system is communicably coupled to the chipset, wherein data is collected using the chipset and transferred to the computing system for processing. The UAV 2 comprises at least one imaging device 21, a navigation control system 22, a chipset 23 and a data storage device 24. In the preferred embodiment of the present invention, the UAV 2 is a rotorcraft comprising a hovering system such as, but not limited to, a helicopter or quadrotor type aerial vehicle with the ability to hover and to fly vertically, forward, backward, laterally or any other desired direction. The UAV 2 is flown by the navigation control system 22 around a structure 1 while scanning, or continually capturing digital images of the structure 1 which are later used to create a virtual model of the structure 1. The UAV 2 may also comprise additional components and sensors, such as, but not limited to, a lighting fixture, flight stabilizers, a digital display, a control panel, or various data transfer ports, cables or other interface components.

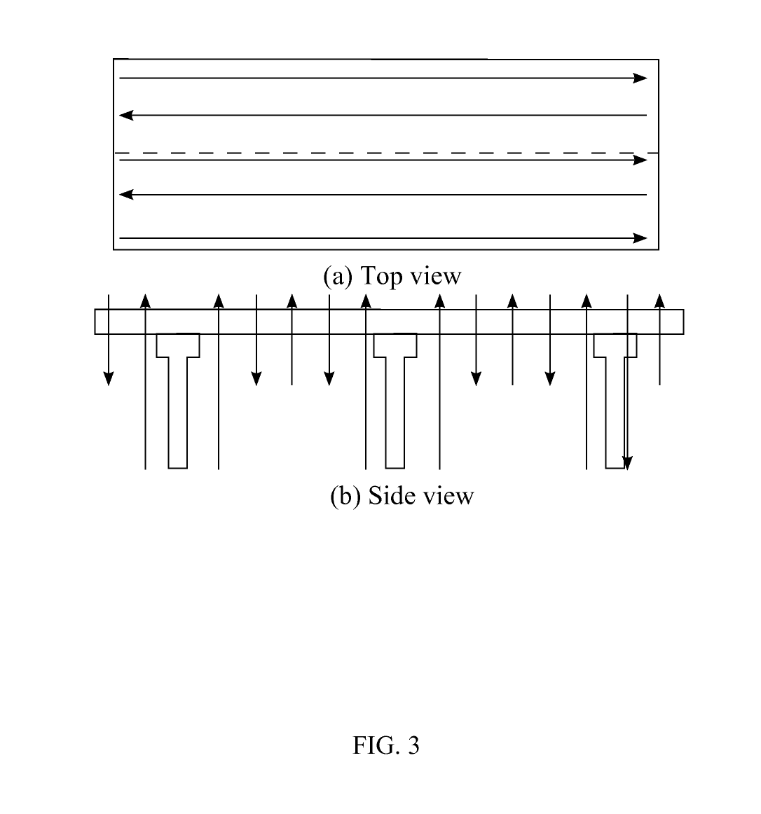

The position tracking system 3 tracks the position of the UAV 2 in real time, and performs in conjunction with the navigation control system 22 to enable the UAV 2 to be flown in a desired scan pattern around the structure 1. An example scan pattern is shown in FIG. 3. In the preferred embodiment of the present invention, each of the at least one imaging device 21 is a digital camera, and the at least one imaging device 21 comprises two digital high definition cameras. It is contemplated that in alternate embodiments alternate or additional imaging devices may be used, such as, but not limited to infrared spectrum cameras. Sonar technology may also be incorporated if desired. The navigation control system 22 is preferably integrated with the chipset 23 and comprises any software programming and physical components necessary to control the flight of the UAV 2. The chipset 23 is a component or combination of components of the electronic variety such as, but not limited to, circuit boards, wires, and processors necessary to facilitate the translation of electrical input signals into desired effects in the operation of the system. The chipset 23 may also be a single microprocessor. In the preferred embodiment of the present invention, the data storage device 24 is a compact solid state drive (SSD) that is physically connected on the UAV 2. In an alternate embodiment, the data storage device 24 may be located in a separate ground based computer to which data is transferred wirelessly.

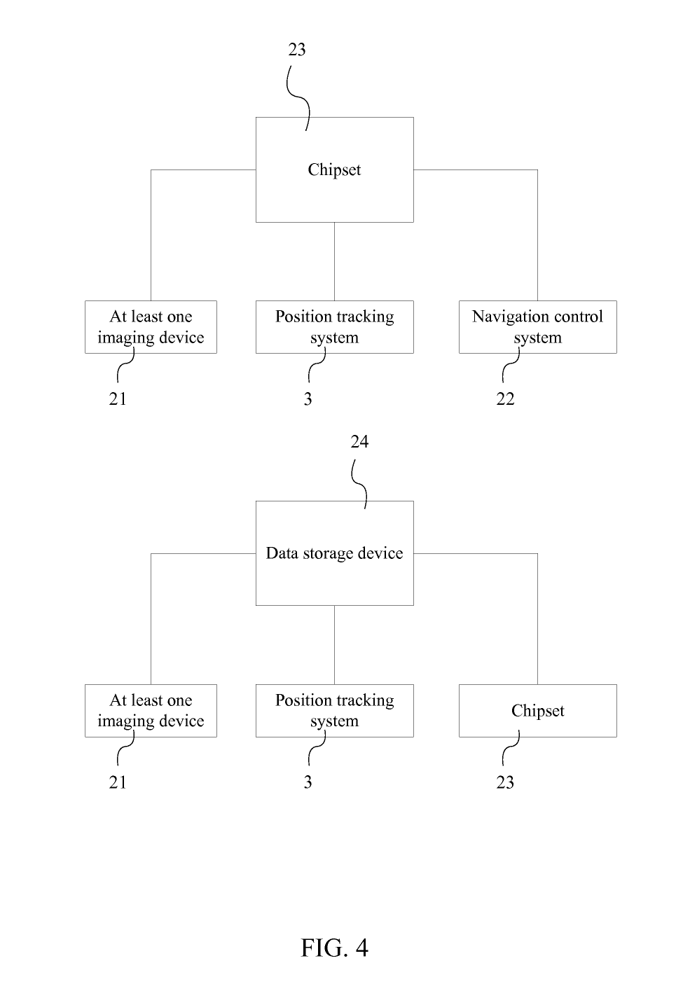

Referring to FIG. 4, the at least one imaging device 21, the navigation control system 22 and the position tracking system 3 are electronically connected to the chipset 23. The position tracking system 3, the at least one imaging device 21, and the chipset 23 are electronically connected to the data storage device 24. Any electronic components requiring electronic power are also electrically connected to a power source, which is preferably a rechargeable or replaceable battery carried by the UAV 2. Alternately, the UAV 2 may conceivably be supplied with electrical power through a physical electrical cable connecting the UAV 2 to a stationary power source positioned on the ground or elsewhere near or around the structure 1. This cabled power supply, however, is unlikely to be utilized due to the cable physically limiting the range and/or path of the UAV 2. Complementary data can be collected using additional sensors (such as infrared cameras or laser scanners) mounted on the same UAV 2 platform or additional platforms capable of detecting and registering position tracking system 3 targets.

In the preferred embodiment of the present invention, the position tracking system 3 is an indoor global positioning system (iGPS) comprising a positioning and orientation sensor 31 and a plurality of position reference targets 32. The positioning and orientation sensor 31 is mounted on the UAV 2 and the plurality of position reference targets 32 are distributed on the structure 1, wherein at least two position reference targets 32 are within view of the UAV 2 at any given time. The current position of the UAV 2 is calculated by triangulation with the position reference targets 32. The current position is used by the navigation system to maintain a correct scan pattern and is also linked to each image taken by the at least one imaging device 21.

In the preferred embodiment of the present invention, ACMS functions supported by iGPS utilize tripod mounted infrared scanners that rotate around a 360 degree field and scan a 150 degree solid angle at each incremental rotation position. For ACMS, at least three of these tripods are positioned on a bridge deck or within UAV 2 mounted iGPS sensor range on the underside of bridges. At last two iGPS tripod mounted scanners must be in view of the ACMS UAV 2 at any given time. Currently, iGPS can collect data from an ACMS UAV 2 platform at 40 meters or more of range. For large scale bridges, ACMS data will typically be collected using 40 meter increments of metrology enabled space, (reusing the same iGPS tripods and targets for each 40 meter increment). It should be noted that the previous description should not be considered to be limiting to the present invention and is simply a description of the current technology utilized in the preferred embodiment of the present invention.

In a second embodiment, the position tracking system 3 is a visual inertial odometry (VIO) system comprising an inertial measurement unit (IMU 33) and an initial position reference target 34. In this second embodiment, the current position of the UAV 2 is calculated by inertial measurements taken by the IMU 33 relative to the initial position reference target 34. The IMU 33 collects inertial measurements using integrated accelerometers and gyros. VIO utilizes the IMU 33 and mono or stereo camera sensor inputs from the at least one imaging device 21 to obtain synchronized, time stamped UAV 2 position (x, y, z) and attitude (pitch, roll, yaw) information corresponding to each stereo image pair collected. Initial absolute position information collected via the initial position reference target 34, otherwise known as a Virtual Reference Station [VRS] is needed to provide absolute position accuracy using VIO. VIO can provide acceptable ACMS accuracy (<0.125 inch) without iGPS position reference targets 32 or sensors. In the preferred embodiment the IMU 33 is selected to incorporate solid state MEMS technologies that are lightweight and accurate. An additional feature that can improve the robustness and accuracy of the present invention is a plurality of radio frequency identification (RFID) monuments installed in permanent, stable, survey accurate positions adjacent to the structure 1 for accurate position referencing. A reference database of position calibration information using known positions of permanent RFID monuments can be accessed when an RFID monument is detected to certify or recalibrate UAV 2 position information. RFID monuments on the structure 1 can be used to tie measurements and images captured to known reference locations.

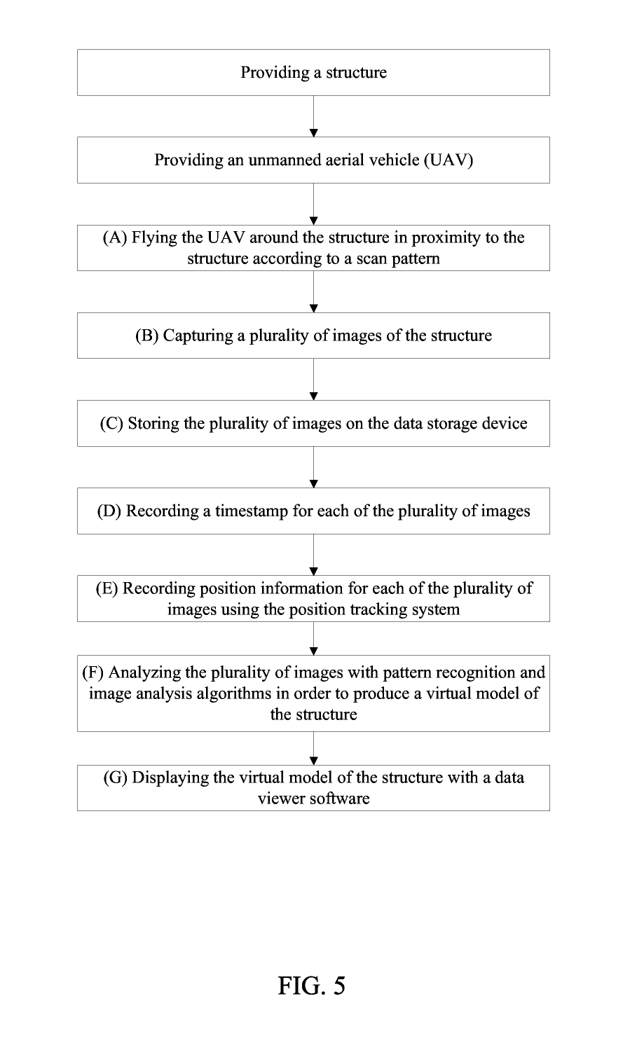

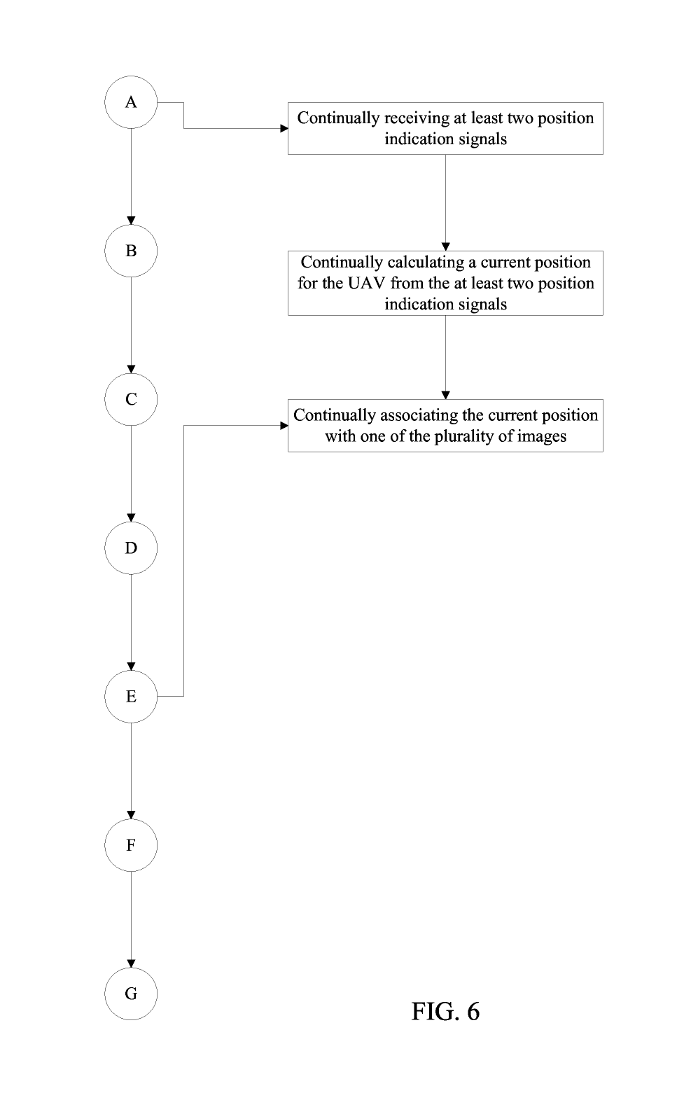

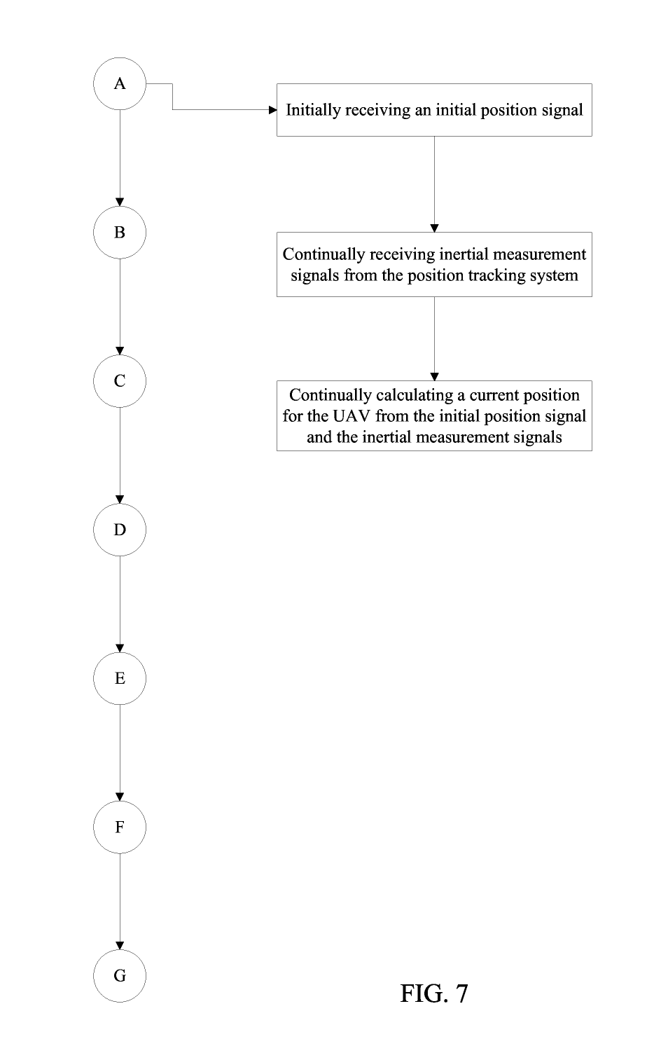

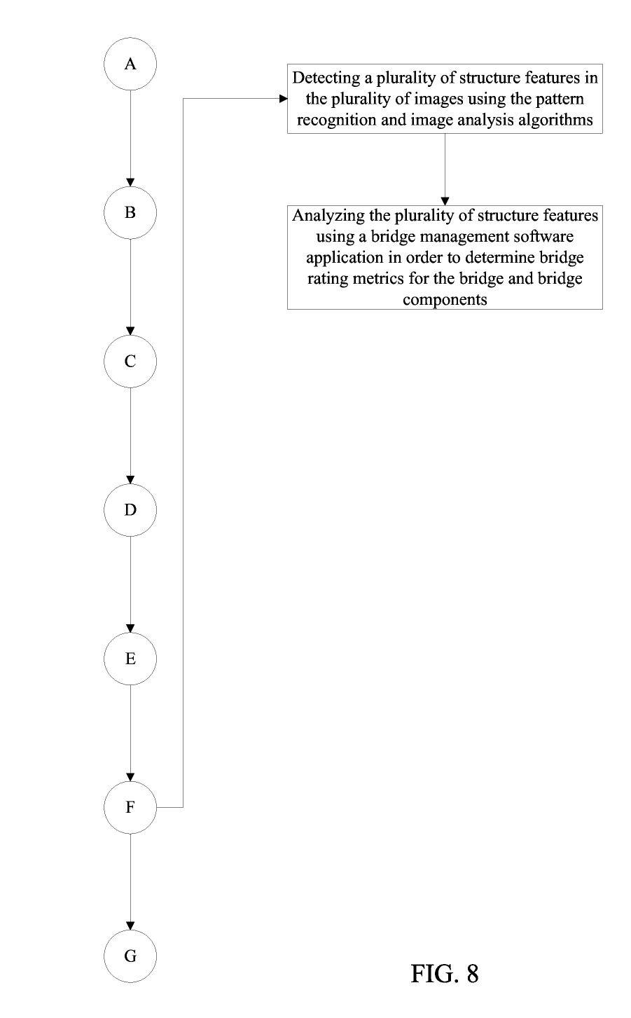

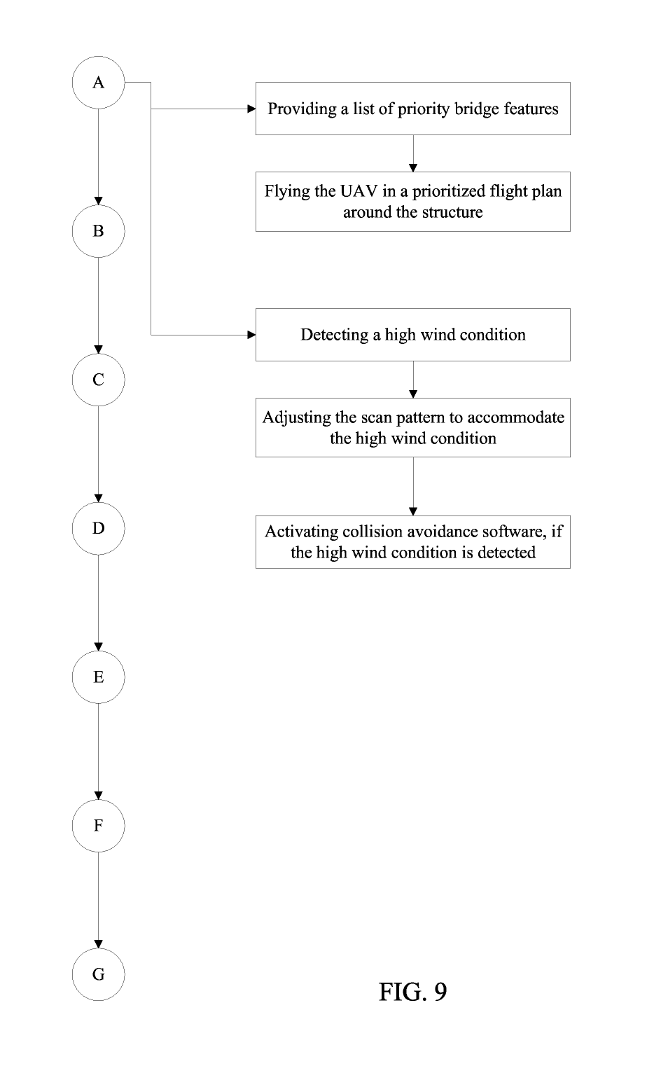

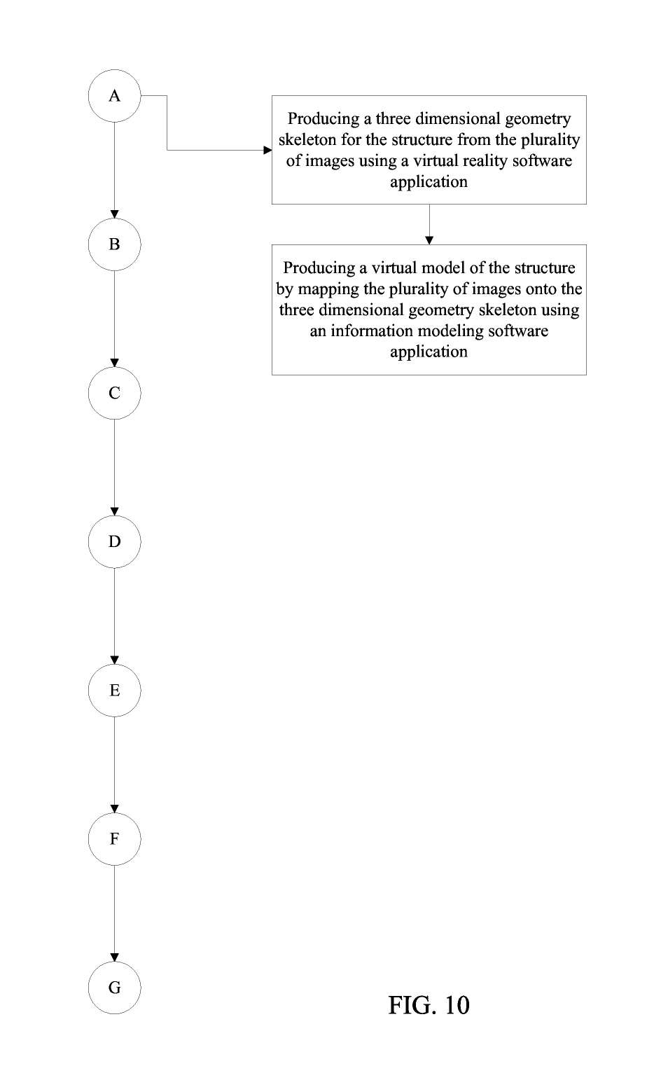

Referring to FIGS. 5-10, in the method of the present invention, a structure 1 is provided, wherein the structure 1 is a bridge or another structure 1 to be inspected. The aforementioned UAV 2 is provided as well. The UAV 2 is flown around the structure 1 in proximity to the structure 1 according to a scan pattern, wherein the scan pattern defines a spatial pattern about the structure 1 for the UAV 2 to traverse while capturing images of the structure 1. The scan pattern should sufficiently traverse the entire surface area of the structure 1 and any substructure is or superstructure ls. In one embodiment of the present invention, the scan pattern is a preprogrammed pattern. In another embodiment, the scan pattern is generated on the fly using a generalized real-time automated navigation algorithm.

The scan pattern can be modified in various ways. One way the scan pattern can be modified is by prioritizing coverage of certain features. To this end, a list of priority bridge features is provided, and the UAV 2 is flown in a prioritized flight plan around the structure 1, wherein the prioritized flight plan focuses scan coverage on the list of priority bridge features. Another modification to the scan pattern of the UAV 2 which can be made is to mitigate high wind conditions. If a high wind condition is detected, the scan pattern is adjusted to accommodate the high wind condition according to a wind disturbance mitigation algorithm. Additionally, collision avoidance software or algorithms should be implemented if the high wind condition is detected to avoid damage to the UAV 2 due to crashing into the structure 1. Another feature that can be provided is a lighting fixture for illuminating poor lighting conditions. If a low lighting condition is detected, the lighting fixture is activated and the lighting fixture is aimed in a desired direction, wherein the desired direction corresponds to a portion of the structure 1 currently being scanned in order to properly illuminate the structure 1.

A plurality of images is captured using the at least one imaging device 21 at a periodic rate, which are stored on the data storage device 24. A timestamp is recorded for each of the plurality of images, and position information is recorded for each of the plurality of images using the position tracking system 3, wherein the position information indicates the spatial position of the UAV 2 at the time each of the plurality of images was taken. The plurality of images, timestamps and position information for each of the plurality of images are recorded on the data storage device 24 and later transferred to the database for processing.

After the plurality of images is recorded, the plurality of images is stitched together using position and time registered location data and analyzed with pattern recognition and image analysis algorithms in order to produce a virtual model of the structure 1. Image processing and pattern recognition software is used to detect and identify features of interest within the plurality of images, including bridge components and deterioration or distress phenomena such as, but not limited to, material cracking, paint chipping, or paint discoloration. Subsequently, the virtual model of the structure 1 is displayed with a data viewer software in order to perform a virtual inspection of the structure 1.

In the first embodiment comprising iGPS as the position tracking system 3, at least two position indication signals are received by the chipset 23. The at least two position indication signals each correlate to one of the position reference targets 32 distributed on the structure 1. A current position is continually calculated for the UAV 2 from the at least two position indication signals through triangulation. The current position is used to maintain a correct scan pattern while navigating around the structure 1, and additionally the current position is continually associated with one of the plurality of images, wherein the one of the plurality of images is the newest image taken. The current position is defined according to a coordinate system containing the structure 1. The iGPS can be used to measure the relative position of image features within better than survey accuracy (<1 mm in three dimensions) based on images that include iGPS targets. ACMS uses this data to build IMs that support visualization of bridge details at scales of interest to engineers and decision makers (up to full scale and down to <1 mm).

In the second embodiment comprising the VIO system as the position tracking system 3, an initial position signal is initially received. The initial position serves as a zero or calibration point for the position tracking system 3. During flight, inertial measurement signals are continually produced by the IMU 33 and continually received by the navigation system, wherein the inertial measurement signals indicate linear and angular accelerations for the UAV 2, which are used to calculate changes in velocity and position. The current position is continually calculated for the UAV 2 from the initial position signal and the inertial measurement signals.

After the plurality of images is collected, the plurality of images is transferred to the database for post processing. In post-processing, the pattern recognition and image analysis algorithms are used to detect a plurality of structure 1 features in the plurality of images, wherein the structure 1 features may include, but are not limited to, cracks, bridge decks, joints, or other features. The plurality of structure 1 features is analyzed using a bridge management software application in order to determine bridge rating metrics for the bridge and bridge components. The post processing algorithms minimize the position error of image features of interest based on multiple views of the features from known locations and perspectives combined with metrology target locations within images, where applicable.

A three dimensional geometry skeleton is produced for the structure 1 from the plurality of images using a virtual reality software application, and a virtual model of the structure 1 is produced by mapping the plurality of images onto the three dimensional geometry skeleton using an information modeling software application. A virtual inspection of the bridge is subsequently carried out using the virtual model of the structure 1, by displaying the virtual model in a three-dimensional software environment. A user may perform a visual inspection of the structure 1 by viewing the virtual model of the structure 1 in the three-dimensional software environment. This provides a great benefit in streamlining the inspection process for bridges and other structure is as the user no longer is required to make judgments about the state of the structure 1 in person, since the three dimensional environment allows the user to virtually navigate around the structure 1. The three dimensional software environment allows results from the post processing algorithms to be used for inspection, quantitative measurements (within accuracy limits), defect and deterioration visualization, structure 1 element investigation, on-site inspection planning (as may be required), and customizable viewing and analysis options.

Although the invention has been explained in relation to its preferred embodiment, it is to be understood that many other possible modifications and variations can be made without departing from the spirit and scope of the invention as hereinafter claimed.

What is claimed is:

1. An automated civil infrastructure metrology system for inspection, analysis, and information modeling of a bridge or other structure comprises:
an unmanned aerial vehicle (UAV) comprising at least one imaging device, a navigation control system, a chipset and a data storage device;
a position tracking system for the UAV;
a computing system, wherein the computing system runs a pattern recognition and image analysis software;
the at least one imaging device, the navigation control system, and the position tracking system being electronically connected to the chipset;
the position tracking system, the at least one imaging device, and the chipset being electronically connected to the data storage device; and
the computing system being communicably coupled to the chipset, wherein data is collected using the chipset and processed using the computing system.

2. The automated civil infrastructure metrology system for inspection, analysis, and information modeling of a bridge or other structure as claimed in claim 1 comprises:
the position tracking system being an indoor global positioning system (iGPS) comprising a positioning and orientation sensor and a plurality of position reference targets;
the positioning and orientation sensor being mounted on the UAV; and
the plurality of position reference targets being distributed on the structure, wherein at least two position reference targets are within view of the UAV at any given time.

3. The automated civil infrastructure metrology system for inspection, analysis, and information modeling of a bridge or other structure as claimed in claim 1 comprises:
the position tracking system being a visual inertial odometry (VIO) system comprising an inertial measurement unit (IMU) and an initial position reference target, wherein the current position of the UAV is calculated by inertial measurements taken by the IMU relative to the initial position reference target.

4. The automated civil infrastructure metrology system for inspection, analysis, and information modeling of a bridge or other structure as claimed in claim 1 comprises:
the UAV comprises a hovering system.

5. The automated civil infrastructure metrology system for inspection, analysis, and information modeling of a bridge or other structure as claimed in claim 1 comprises:
each of the at least one imaging device being a digital camera.

6. A method of automated civil infrastructure metrology for inspection, analysis, and information modeling comprises the steps of:
providing a structure, wherein the structure is a bridge or another structure to be inspected;
providing an unmanned aerial vehicle (UAV) comprising at least one imaging device, a position tracking system, and a data storage device;
flying the UAV around the structure in proximity to the structure according to a scan pattern, wherein the scan pattern defines a spatial pattern about the structure for the UAV to traverse while capturing images of the structure;
capturing a plurality of images of the structure using the at least one imaging device;
storing the plurality of images on the data storage device;
recording a timestamp for each of the plurality of images;
recording position information for each of the plurality of images using the position tracking system, wherein the position information indicates the spatial position of the UAV at the time each of the plurality of images was taken;
analyzing the plurality of images with pattern recognition and image analysis algorithms in order to produce a virtual model of the structure, wherein image processing and pattern recognition software is used to detect and identify features of interest within the plurality of images, including bridge components and deterioration or distress phenomena; and
displaying the virtual model of the structure with a data viewer software.

7. The method of automated civil infrastructure metrology for inspection, analysis, and information modeling by executing computer-executable instructions stored on a non-transitory computer-readable medium as claimed in claim 6 comprises the steps of:
continually receiving at least two position indication signals;
continually calculating a current position for the UAV from the at least two position indication signals, wherein the position tracking system is an iGPS; and
continually associating the current position with one of the plurality of images, wherein the one of the plurality of images is the newest image taken.

8. The method of automated civil infrastructure metrology for inspection, analysis, and information modeling by executing computer-executable instructions stored on a non-transitory computer-readable medium as claimed in claim 6 comprises the steps of:
initially receiving an initial position signal;
continually receiving inertial measurement signals from the position tracking system,
wherein the position tracking system is a visual inertial odometry system;
wherein the inertial measurement signals indicate a change in position, velocity or acceleration for the UAV; and
continually calculating a current position for the UAV from the initial position signal and the inertial measurement signals.

9. The method of automated civil infrastructure metrology for inspection, analysis, and information modeling by executing computer-executable instructions stored on a non-transitory computer-readable medium as claimed in claim 6 comprises the steps of:
detecting a plurality of structure features in the plurality of images using the pattern recognition and image analysis algorithms; and
analyzing the plurality of structure features using a bridge management software application in order to determine bridge rating metrics for the bridge and bridge components.

10. The method of automated civil infrastructure metrology for inspection, analysis, and information modeling by executing computer-executable instructions stored on a non-transitory computer-readable medium as claimed in claim 6, wherein the scan pattern is a preprogrammed pattern.

11. The method of automated civil infrastructure metrology for inspection, analysis, and information modeling by executing computer-executable instructions stored on a non-transitory computer-readable medium as claimed in claim 6, wherein the UAV is flown around the structure according to a generalized real-time automated navigation algorithm.

12. The method of automated civil infrastructure metrology for inspection, analysis, and information modeling by executing computer-executable instructions stored on a non-transitory computer-readable medium as claimed in claim 6 comprises the steps of:
providing a list of priority bridge features; and
flying the UAV in a prioritized flight plan around the structure, wherein the prioritized flight plan focuses scan coverage on the list of priority bridge features.

13. The method of automated civil infrastructure metrology for inspection, analysis, and information modeling by executing computer-executable instructions stored on a non-transitory computer-readable medium as claimed in claim 6 comprises the steps of:
detecting a high wind condition; and
adjusting the scan pattern to accommodate the high wind condition.

14. The method of automated civil infrastructure metrology for inspection, analysis, and information modeling by executing computer-executable instructions stored on a non-transitory computer-readable medium as claimed in claim 13 comprises the steps of:
activating collision avoidance software, if the high wind condition is detected.

15. The method of automated civil infrastructure metrology for inspection, analysis, and information modeling by executing computer-executable instructions stored on a non-transitory computer-readable medium as claimed in claim 6 comprises the steps of:
providing a lighting fixture on the UAV;
detecting a low lighting condition;
activating the lighting fixture, if the low lighting condition is detected; and
aiming the lighting fixture in a desired direction, wherein the desired direction corresponds to a portion of the structure currently being scanned.

16. The method of automated civil infrastructure metrology for inspection, analysis, and information modeling by executing computer-executable instructions stored on a non-transitory computer-readable medium as claimed in claim 6 comprises the steps of:
producing a three dimensional geometry skeleton for the structure from the plurality of images using a virtual reality software application; and
producing a virtual model of the structure by mapping the plurality of images onto the three dimensional geometry skeleton using an information modeling software application.

17. The method of automated civil infrastructure metrology for inspection, analysis, and information modeling by executing computer-executable instructions stored on a non-transitory computer-readable medium as claimed in claim 16, wherein a virtual inspection of the bridge is carried out using the virtual model of the structure.
